(19) United States
(12) Patent Application Publication
(10) Pub. No.: US 2007/0214630 A1
(43) Pub. Date: Sep. 20, 2007

(54) METHOD FOR MANUFACTURING DRUM AND WASHING MACHINE USING THE DRUM

(75) Inventor: Woo Young KIM, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/684,089

(22) Filed: Mar. 9, 2007

(30) Foreign Application Priority Data
Mar. 16, 2006 (KR) 10-2006-0024451

(51) Int. Cl. D06F 21/00; B23P 11/00

(52) U.S. Cl. 29/505; 68/142

(57) ABSTRACT

A washing machine is disclosed. The washing machine includes a drum body provided with through holes for allowing air or wash water to enter or exit the drum body, and a seam extending in a longitudinal direction of the drum body such that at least a portion of the seam has an inclination with respect to a central axis of the drum body.

This application claims the benefit of Korean Patent Application No. 10-2006-0024451, filed on Mar. 16, 2006, which is hereby incorporated by reference as if fully set forth herein.

### BACKGROUND OF THE INVENTION

1. Field of the Invention

The present invention relates to a method for manufacturing a drum and a washing machine using the drum, and more particularly to a method for manufacturing a drum having a strength-enhanced structure and a washing machine using the drum.

2. Discussion of the Related Art

Generally, washing machines perform washing, rinsing, and spin-drying operations, in order to remove contaminants attached to laundry using interaction of detergent and water. Such washing machines are classified into a cylinder or drum type, an agitator type, and a pulsator type in accordance with the washing system used.

The agitator type washing system is a system in which a blade-shaped agitator upwardly protruded from the central portion of a washing tub rotates clockwise and counterclockwise, to perform a washing operation. The pulsator type washing system is a system in which a disc-shaped pulsator rotates to generate a flow of water, in order to perform a washing operation.

In the drum type washing system, a drum provided with a plurality of lifts rotates at low speed about a horizontal axis under the laundry contained in the drum along with water and detergent. In accordance with the rotation of the drum, the laundry is washed by the impact generated when the laundry falls down after being raised by the lifts, and the frictional forces generated among the pieces of the laundry. Recently, the use of this system has increased due to the advantages of no or little damage of laundry and reduced water use.

A conventional drum equipped in a drum washing machine will be described in brief with reference to FIG. 1.

The conventional drum 1, which has a cylindrical shape, includes a seam 3 extending in parallel to the longitudinal direction of the drum 1. The seam 3 is formed by rolling a metal plate such that the metal plate has a hollow cylindrical shape, so as to form a drum, and connecting opposite ends of the rolled metal plate.

When the rotating speed of the drum 3 in the conventional drum washing machine increases during a spin-drying cycle, the laundry received in the drum is pressed against the inner wall surface of the drum 3 due to a centrifugal force applied to the laundry. As a result, tension is applied to the seam 3.

In this case, the tension is directly applied to the seam 3 throughout the length of the seam 3. For this reason, there is a problem in that, as the rotating speed of the drum 3 increases, the seam 3 may be more easily deformed or fractured.

### SUMMARY OF THE INVENTION

Accordingly, the present invention is directed to a method for manufacturing a drum and a washing machine using the drum that substantially obviate one or more problems due to limitations and disadvantages of the related art.

An object of the present invention is to achieve an increase in the strength of a seam of the drum body of a drum during the rotation of the drum.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing machine comprises: a drum body provided with through holes for allowing air or wash water to enter or exit the drum body; and a seam extending in a longitudinal direction of the drum body such that at least a portion of the seam has an inclination with respect to a central axis of the drum body.

The seam may include a depressed portion formed in accordance with a depressing process to increase a coupling force at the seam.

The depressed portion may be depressed in a direction perpendicular to a longitudinal direction of the seam.

The depressed portion may be depressed in a direction perpendicular to the longitudinal direction of the drum body.

The seam may be formed at an outer peripheral surface of the drum body.

The seam may have a predetermined inclination with respect to the drum body at an overall portion of the seam.

The depressed portion may comprise a plurality of uniformly-spaced depressed portions.

In another aspect of the present invention, a washing machine comprises: a drum body provided with through holes for allowing air or wash water to enter or exit the drum body; and a seam configured such that tensions in circumferential and longitudinal directions of the drum body are simultaneously applied to at least a portion of the seam during a rotation of the drum body.

In another aspect of the present invention, a method for manufacturing a drum, comprises: cutting a plate; rolling the cut plate to form a cylindrical drum body; bending two opposite sides of the rolled plate in contact with each other; and seaming the bent opposite sides of the rolled plate, to form a seam, wherein the cutting of the plate is carried out such that at least a portion of the seam has an inclination with respect to the drum body.

The step of cutting the plate comprises cutting the plate into a parallelogram shape such that the seam has an inclination with respect to the drum body at an overall portion of the seam.

The method may further comprise pressing the seam to increase a coupling force at the seam.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a front view schematically illustrating a conventional drum;

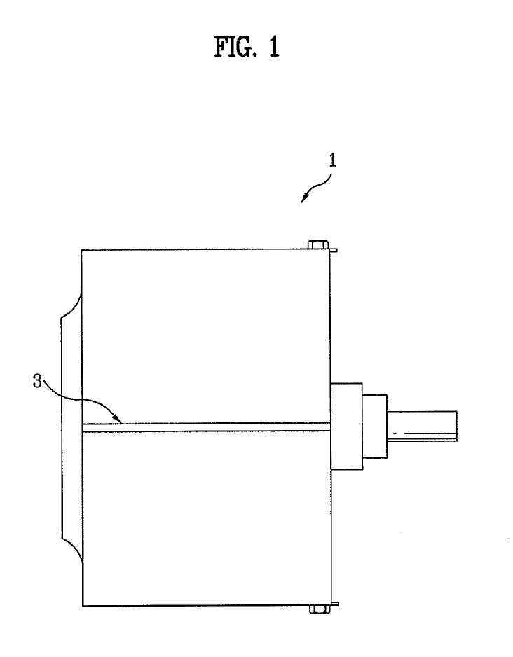

FIG. 2 is a front view schematically illustrating a drum according to an embodiment of the present invention;

FIG. 3 is a developed view of a drum body included in the drum of FIG. 2;

FIG. 4 is a cross-sectional view taken along the line A-A of FIG. 2;

FIG. 5 is an exploded view of a seam included in the drum of FIG. 2;

FIG. 6 is a view for explaining tension applied to the seam according to the present invention; and

FIG. 7 is a front view schematically illustrating a drum according to another embodiment of the present invention.

### DETAILED DESCRIPTION OF THE INVENTION

Reference will now be made in detail to the preferred embodiments of the present invention, examples of which are illustrated in the accompanying drawings.

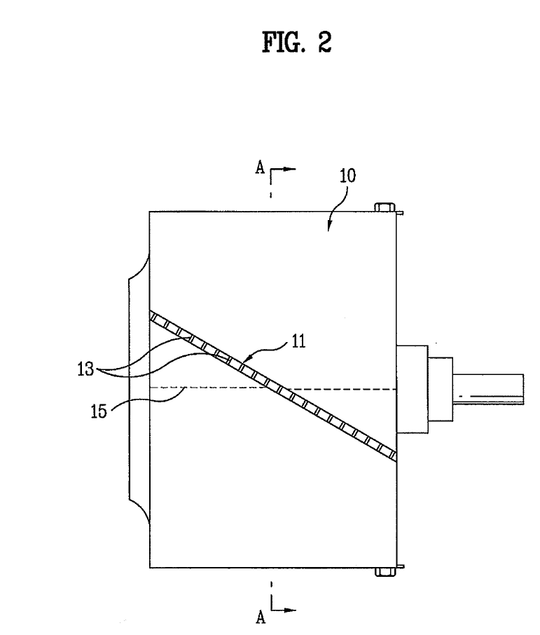

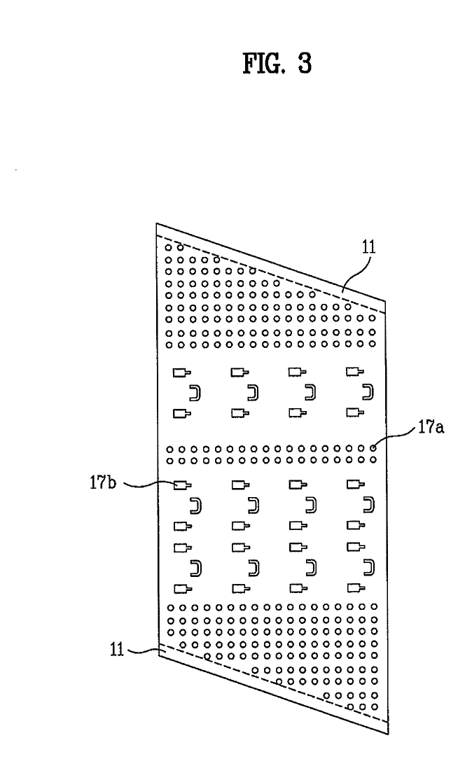

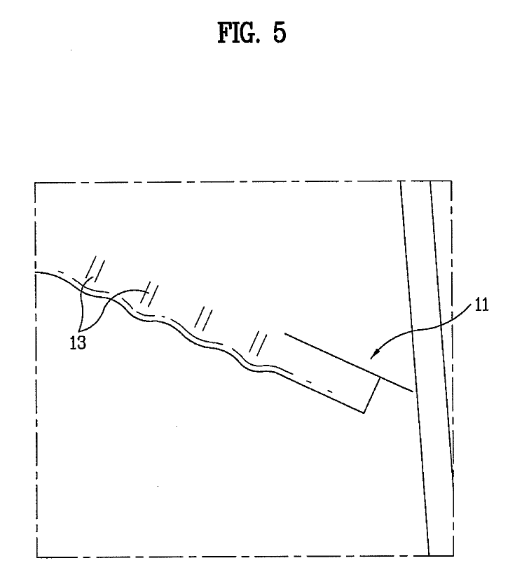

In FIGS. 2 to 5 a drum according to an exemplary embodiment of the present invention is illustrated. The drum includes a drum body 10 provided with through holes 17a, through which air or wash water passes, and a seam 11 formed in the longitudinal direction of the drum body 10. Mounting holes 17b are also formed through the drum body 10 to mount lifts to the drum body 10.

The drum body 10 has a hollow cylindrical shape. As shown in FIG. 2, the drum body 10 is formed by rolling a diamond-shaped flat plate. When the flat plate is longitudinally rolled to form a hollow cylindrical structure, the opposite ends of the flat plate come into contact with each other. As the opposite plate ends are seamed, the seam 11 is formed.

Since the flat plate has a diamond shape, the seam 11 formed by rolling the flat plate has a certain inclination with respect to a central axis 15 of the drum body 10.

In the illustrated embodiment, the seam 11 has an inclination with respect to the central axis 15 of the drum body 10 throughout the overall portion of the seam 11. Of course, the present invention is not limited to this embodiment. The seam 11 may have an inclination with respect to the central axis 15 of the drum body 10 through at least a portion of the seam 11.

The seam 11 is formed at the outer peripheral surface of the drum body 10. The seam 11 includes depressed portions 13 formed in accordance with a pressing process to increase the coupling force of the seam 11. The depressed portions 13 have a groove shape due to a pressing operation carried out using a press. Thus, the seam 11 has a protrusion/groove-repeated structure.

As shown in FIG. 2, the depressed portions 13 are formed by pressing the seam 11 in a direction perpendicular to the longitudinal direction of the seam 11. Since the depressed portions 13 are pressed in the above-described direction, they may function to distribute the tension applied to the drum due to the centrifugal force of the laundry during the rotation of the drum.

Preferably, a plurality of depressed portions 13 are formed such that they are uniformly spaced. This is because, when an increased number of depressed portions 13 are uniformly distributed, it is possible to more uniformly distribute the tension applied to the seam 11 of the drum, and thus to more firmly secure the coupling provided by the seam 11.

In detail, the level of the tension applied to each depressed portion 13 when tension of a certain level is applied to the seam 11 is reduced as the number of the depressed portions 13 increases in accordance with the distribution of the tension to the depressed portions 13. Accordingly, the strength of the seam 11 withstanding the tension increases.

In this connection, the inclination of the seam 11 with respect to the central axis of the drum body 10 results in an increase in the length of the seam 11. Accordingly, it is possible to increase the number of the depressed portions 13, and thus to more securely prevent the seam 11 from being deformed or fractured due to the tension.

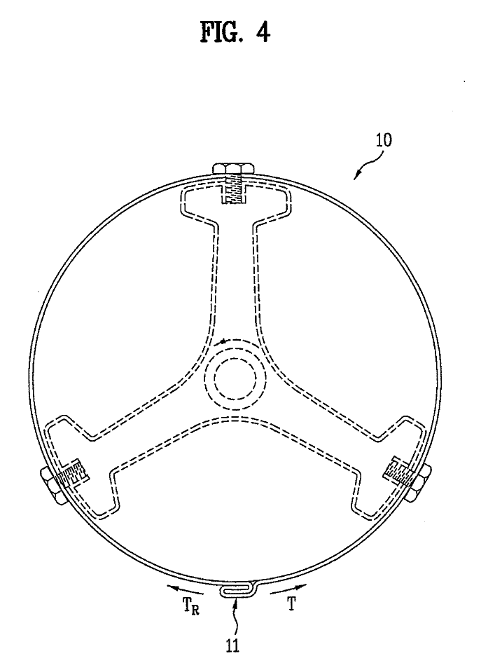

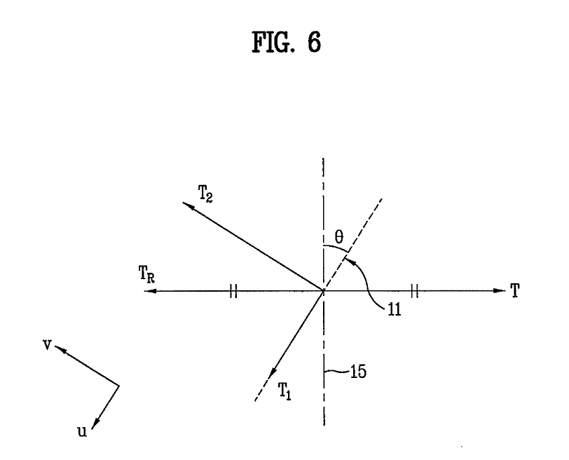

Hereinafter, the division of the tension applied to the drum will be described with reference to FIGS. 4 and 6.

When the drum rotates, tension in a circumferential direction of the drum is generated due to the centrifugal force of the laundry, etc., as shown in FIG. 4. Tensions T and Tr generated at opposite sides of the seam 11 in this case have the same value in accordance with the principle of force equilibrium.

Meanwhile, the tension applied to the seam 11 is divided into component forces because the seam 11 is inclined at an angle θ with respect to the longitudinal direction of the drum, namely the central axis 15 of the drum body 10.

In detail, the tension Tr caused by the rotation of the drum is divided into tensions T₁ and T₂ by virtue of the inclination. That is, tensions in the circumferential and longitudinal directions of the drum body 10 are simultaneously applied to at least a portion of the seam 11 during the rotation of the drum body 10. Here, the tension T₁ corresponds to T_{R} sin θ (T₁=T_{R} sin θ), whereas the tension T₂ corresponds to T_{R} cos θ (T₁=T_{R} sin θ).

Preferably, the inclination of the seam 11 is 45°. This is because the tension applied to the drum is equally divided in the longitudinal direction u of the seam 11 and in the direction v perpendicular to the longitudinal direction u when the inclination of the seam 11 is 45°. Of course, the inclination of the seam 11 may vary in accordance with the selection of the user.

Hereinafter, the procedure for manufacturing the drum according to the present invention will be described with reference to FIGS. 2 to 6.

First, the manufacturer prepares a plate, for example, a metal plate, to be shaped into the drum body 10, in accordance with a cutting process. In the cutting process, the plate is cut such that at least a portion of the seam to be formed by two opposite sides of the plate will have an inclination with respect to the drum body 10. For example, when a hollow cylindrical drum body is formed using a plate cut as a parallelogram, particularly a diamond shape, the seam of the drum body has a certain inclination with respect to the central axis of the drum body.

Thereafter, through holes 17a for the entrance and exit of water or wash water are formed through the metal plate. Mounting holes 17b for mounting lifts are also formed through the metal plate. The through holes 17a and mounting holes 17b may be formed by a punching process. The formation of the through holes 17a and mounting holes 17b may be carried out prior to the cutting of the metal plate.

The diamond-shaped metal plate is then rolled such that the opposite ends of the metal plate come into contact with each other. The opposite ends of the metal plate in contact with each other are then seamed, to form a seam 11. The seam 11 is subsequently pressed at positions uniformly spaced apart from one another, to form depressed portions 13. Thus, the manufacture of the drum body 10 is completed.

Finally, the front side of the drum (not shown), at which an opening for moving laundry in or out of the drum is formed, and the rear side of the drum defining a rear wall of the drum body are coupled to the drum body. Thus, the drum is completely manufactured.

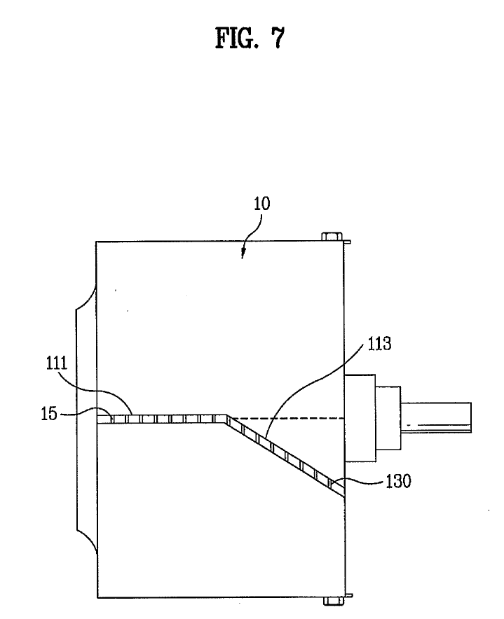

Hereinafter, a drum according to another embodiment of the present invention will be described in brief with reference to FIG. 7.

In the drum according to this embodiment, the seam thereof includes a first seam 11 and a second seam 113, different from the above-described embodiment.

In detail, the first seam 111 extends in parallel to the central axis 15 of the drum body, whereas the second seam 113 has a certain inclination with respect to the central axis 15 of the drum body.

However, the present invention is not limited to such a design. For example, the first seam 111 may have a positive inclination with respect to the drum body, whereas the second seam 113 may have a negative inclination with respect to the drum body.

Each of the first and second seams 111 and 113 includes depressed portions 113 formed by pressing the seam in a direction perpendicular to the longitudinal direction of the drum body.

The above-described drum may be used in a general washing machine or a washing machine equipped with a drier. The washing machine includes a cabinet formed with an opening for moving laundry in or out of the interior of the cabinet, a drum rotatably installed in the cabinet, and a driver for driving the drum. The drum includes a drum body formed with through holes for the entrance or exist of wash water, and a seam extending in the longitudinal direction of the drum body such that at least a portion of the seam has an inclination with respect to the central axis of the drum body.

The details of the drum included in the washing machine are substantially the same as in the above description. The details of the cabinet and driver included in the washing machine according to the present invention will be readily appreciated by those skilled in the art, so no description thereof will be given.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

The above-described drum according to the present invention and the washing machine using the drum have the following effects.

First, it is possible to prevent the seam from being deformed or fractured because the seam is formed such that at least a portion of the seam has an inclination with respect to the central axis of the drum body, to distribute the tension applied to the drum during the rotation of the drum.

Second, it is possible to achieve an increase in the tensile strength of the drum because the seam has a length longer than the drum body, thereby enabling an increase in the number of the depressed portions formed at the seam.

What is claimed is:

1. A washing machine comprising:
a drum body provided with through holes for allowing air or wash water to enter or exit the drum body; and
a seam extending in a longitudinal direction of the drum body such that at least a portion of the seam has an inclination with respect to a central axis of the drum body.

2. The washing machine according to claim 1, wherein the seam includes a depressed portion formed in accordance with a depressing process to increase a coupling force at the seam.

3. The washing machine according to claim 2, wherein the depressed portion is depressed in a direction perpendicular to a longitudinal direction of the seam.

4. The washing machine according to claim 2, wherein the depressed portion is depressed in a direction perpendicular to the longitudinal direction of the drum body.

5. The washing machine according to claim 1, wherein the seam is formed at an outer peripheral surface of the drum body.

6. The washing machine according to claim 1, wherein the seam has a predetermined inclination with respect to a central axis of the drum body at an overall portion of the seam.

7. The washing machine according to claim 2, wherein the depressed portion comprises a plurality of uniformly-spaced depressed portions.

8. The washing machine according to claim 6, wherein the predetermined inclination of the seam is 45°.

9. A washing machine comprising:
a drum body provided with through holes for allowing air or wash water to enter or exit the drum body; and
a seam configured such that tensions in circumferential and longitudinal directions of the drum body are simultaneously applied to at least a portion of the seam during a rotation of the drum body.

10. A method for manufacturing a drum, comprising:
cutting a plate;
rolling the cut plate to form a cylindrical drum body;
bending two opposite sides of the rolled plate in contact with each other; and
seaming the bent opposite sides of the rolled plate, to form a seam,
wherein the cutting of the plate is carried out such that at least a portion of the seam has an inclination with respect to a central axis of the drum body.

11. The method according to claim 10, wherein the step of cutting the plate comprises cutting the plate into a parallelogram shape such that the seam has an inclination with respect to the central axis direction of the drum body at an overall portion of the seam.

12. The method according to claim 10, further comprising:
pressing the seam to increase a coupling force at the seam.
